(19) United States
(12) Patent Application Publication
(10) Pub. No.: US 2012/0240788 A1
(43) Pub. Date: Sep. 27, 2012

(54) AUTOMATIC BREAD MAKER

(76) Inventor: Yasuyuki Ito, Tottori-shi (JP)

(21) Appl. No.: 13/514,154

(22) PCT Filed: Dec. 7, 2010
(86) PCT No.: PCT/JP2010/071867

§ 371 Date: Jun. 6, 2012

(30) Foreign Application Priority Data
Jan. 27, 2010 (JP) 2010-015500

(51) Int. Cl. A21B 7/00; A47J 37/01

(52) U.S. Cl. 99/348; 220/573.1

(57) ABSTRACT

An automatic bread maker 1 accommodates, in a body 10 thereof, a bread container 50 having bread ingredients put therein, and performs a bread making process. In a bottom portion of the bread container 50, a recess 55 is formed. The automatic bread maker 1 is used in a first mode in which the recess 55 is not closed with a lid 90A, and in a second mode in which the recess 55 is closed with the lid 90A.

### TECHNICAL FIELD

The present invention is related to an automatic bread maker for use mainly in general households.

### BACKGROUND ART

Commercially available bread makers for household use are typically structured such that bread is baked by using a bread container, in which bread ingredients are put, as a baking pan. Patent Literature 1 discloses an example of automatic bread makers. With the automatic bread maker disclosed in Patent Literature 1, a bread container in which bread ingredients are put is placed in a baking chamber. Then, the bread ingredients in the bread container are kneaded into dough by the kneading blade. Thereafter, a fermentation process is carried out, and the dough is baked into bread by using the bread container as the baking pan.

There are cases where an optional ingredient such as raisins or nuts are mixed in the bread ingredients to bake bread with an optional ingredient. Patent Literature 2 discloses an automatic bread maker equipped with means for automatically feeding sub bread ingredients such as raisins, nuts, or cheese.

### CITATION LIST

Patent Literature
Patent Literature 1: JP-A-2000-116526

### SUMMARY OF INVENTION

### Technical Problem

Conventionally, a user of an automatic bread maker needs to start bread making by preparing flour made by grinding grains of cereal such as wheat or rice, or ready-mixed flour made of such flour and various auxiliary ingredients mixed together. Even when there are cereal grains (typically rice) available at hand, it is not easy to make bread directly from such cereal grains.

The present invention has been made in view of the above problems, and an object of the present invention is to provide an automatic bread maker equipped with a mechanism that is convenient for making bread directly from cereal grains, and to make bread making easier to work on. It is another object of the present invention to provide an automatic bread maker that can be used not only for baking bread from cereal grains but also for baking bread by using commercially available flour.

### Solution to Problem

To achieve the above object, according to the present invention, in an automatic bread maker which performs a bread making process with bread ingredients put in a bread container which is accommodated in a body, the bread container has a recess formed in a bottom portion thereof, and the bread container is used in a first mode in which the recess is not closed with a lid and in a second mode in which the recess is covered with a lid.

The first mode is assumed to be, for example, a mode for making bread by grinding cereal grains in the bread container, and the second mode is assumed to be, for example, a mode for making bread by using ready-made cereal flour. According to the structure, to make bread in the mode for making bread by grinding cereal grains (a cereal-grain grinding mode) and in the mode for making bread by using ready-made cereal flour (a ready-made flour mode), there is no need of using two different bread containers, but bread-making in the two modes are accomplished just by replacing a component provided at the bottom portion of one bread container. Thus, the automatic bread maker can be distributed for sale in a small package, and can be stored in a small space in a house.

In the automatic bread maker structured as described above, the lid used in the second mode may be structured to be fitted into the recess from above.

With this structure, a top opening portion of the recess can be easily closed.

In the automatic bread maker structured as described above, it is preferable that, in the second mode, an annular seal member be attached to an outer periphery of the lid such that the annular seal member is in tight contact with an inner peripheral surface of the recess.

With this structure, when the lid is fitted into the recess, the annular seal member prevents bread ingredients from entering a space between the recess and the lid, and this helps prevent a ring-shaped projection formed on a bottom of baked bread. The annular seal member also functions as a cushion, and this helps prevent squeak noise from occurring between the bread container and the lid in a bread making operation.

In the automatic bread container structured as described above, a bottom portion of the recess may be formed with an attachable-detachable bottom member, and the lid used in the second mode may be supported by having a peripheral edge thereof held between an edge of the top opening portion of the recess and the bottom member.

With this structure, a user can remove components in the bread container such as the kneading blade, with the baked bread remaining in the bread container, just by detaching the bottom member of the recess. Thus the user can push the bread through an opening appearing after the bottom member is detached, and this makes it easy for the user to completely take the bread out of the bread container.

In the automatic bread maker structured as described above, it is preferable that the bottom member is fastened and fixed to the bread container with a nut having an inner-flange.

With this structure, it is possible to firmly fix the bottom member to the bread container.

In the automatic bread maker structured as described above, it is preferable that an annular seal member be disposed between the lid and the edge of the top opening portion of the recess.

With this structure, when the lid is fitted into the recess, the annular seal member prevents bread ingredients from entering a space between the recess and the lid, and this helps prevent a ring-shaped projection formed on the bottom of the baked bread. The annular seal member also functions as a cushion, and this helps prevent squeak noise from occurring between the bread container and the lid in a bread making operation.

The automatic bread maker structured as described above may be such that a rotation shaft is provided at a bottom portion of the bread container, in the first mode, a grinding blade used for grinding cereal grains and a cover which is provided with a first kneading blade used for kneading bread ingredients into dough and which covers the grinding blade are attached to the rotation shaft, the cover being accommodated in the recess, and in the second mode, the recess is covered with the lid and a second kneading blade is attached to the rotation shaft.

With this structure, it is possible to produce bread ingredients inside the bread container by putting cereal grains in the bread container and grinding them with the grinding blade. Thereafter, kneading of the bread ingredients can be performed by using the first kneading blade, and the procedure can further proceed in the bread container to fermentation and baking processes. The cereal grains ground in the bread container can be baked into bread in the same bread container, and thus, in contrast to a structure in which cereal grains are first ground in another container and then shifted to the bread container, this structure is free from volume loss of cereal grains resulting from such shifting (volume loss caused by some of the cereal grains being left in the another container without moving into the bread container). Furthermore, the grinding blade and the kneading blade can be left inside the bread container from the grinding of cereal grains until the end of baking operation, and moreover, switching between the grinding blade and the kneading blade can be done simply by changing the rotation direction of the blade rotation shaft, which makes the machine easy to handle. With this structure, the grinding blade grinds cereal grains inside the cover, and this prevents the cereal grains from scattering outside the bread container during a grinding process.

In addition, by disposing the lid for closing the top opening portion of the recess and the second kneading blade (independent kneading blade) unrotatably coupled to the blade rotation shaft in the bread container after the grinding blade and the cover are detached, bread can be made by using ready-made cereal flour that does not have to go through the grinding process. Instead of using two bread containers as the bread container in the cereal-grain grinding mode and in the ready-made flour mode, just the components at the bottom of the bread container are replaced, and thus, the automatic bread maker can be distributed for sale in a small package, and can be stored in a small space in a house.

And, in this structure, if a bottom portion of the recess is formed with an attachable-detachable bottom member, it is possible to remove the bottom member of the recess with baked bread in the bread container, and to remove components, such as the grinding blade and the cover in the cereal-grain grinding mode and components such as the second kneading blade (the independent kneading blade) in the ready-made flour mode, from the bread. For this purpose, it is preferable that sizes of the recess and of the second kneading blade be set such that the second kneading blade, remaining attached to the blade rotation shaft, can be pulled downward from the recess when the bottom member is detached from the bread container.

### Advantageous Effects of Invention

According to the present invention, it is possible to bake bread by using cereal grains at hand, and thus there is no need of buying cereal flour as a bread ingredient. In the case of using rice, bread can be baked by using rice grains of any polishing rate from brown to white. And, since the processes from the grinding of cereal grains to the baking of bread can be all carried out in the bread container placed inside the baking chamber, there is less risk of undesired mixing of foreign matter into dough. Furthermore, in contrast to a structure in which cereal grains are first ground in another container and then shifted into the bread container, this structure is free from volume loss resulting from such shift due to some of the cereal grains sticking to and thus being left in the container. Moreover, since the grinding blade and the kneading blade stay and operate inside the bread container from beginning to end, they are easy to handle, and the grinding can be carried out without cereal grains scattering outside the bread container. In addition, by disposing the lid for closing the top opening portion of the recess and the independent kneading blade unrotatably coupled to the blade rotation shaft in the bread container after the grinding blade and the cover are removed, bread can be made by using ready-made cereal flour that does not have to go through the grinding process. Instead of using two bread containers as the bread container in the cereal-grain grinding mode and in the ready-made flour mode, just the components at the bottom of the bread container are replaced, and thus, the automatic bread maker can be distributed for sale in a small package, and can be stored in a small space in a house.

### BRIEF DESCRIPTION OF DRAWINGS

FIG. 1 A vertical sectional view showing an automatic bread maker of a first embodiment of the present invention;

FIG. 2 A vertical sectional view showing the automatic bread maker of FIG. 1 taken along a line orthogonal to the line along which FIG. 1 is taken;

FIG. 3 A vertical sectional view showing a bread container of the automatic bread maker of the first embodiment;

FIG. 4 A bottom plan view showing a cover of the automatic bread maker of the first embodiment as being covered with a guard;

FIG. 5 A vertical sectional view showing the cover of the automatic bread maker of the first embodiment as being covered with the guard;

FIG. 6 A perspective view as seen from above showing the cover and a kneading blade of the automatic bread maker of the first embodiment;

FIG. 7 A top plan view showing the cover and the kneading blade of the automatic bread maker of the first embodiment;

FIG. 8 A perspective view as seen from below showing the cover and the kneading blade of the automatic bread maker of the first embodiment;

FIG. 9 A bottom plan view of the cover and the kneading blade of the automatic bread maker of the first embodiment;

FIG. 10 A top plan view showing the bread container of the automatic bread maker of the first embodiment in a grinding process;

FIG. 11A top plan view showing the bread container in a grinding process, showing a state different from the state shown in FIG. 10;

FIG. 12 A perspective view showing the guard of the automatic bread maker of the first embodiment;

FIG. 13 A side view showing the guard of the automatic bread maker of the first embodiment;

FIG. 14 A vertical sectional view showing the bread container of the automatic bread maker of the first embodiment when an independent kneading blade and a lid is put in place after the grinding blade and the cover are taken off;

FIG. 15 An enlarged view of part of FIG. 14;

FIG. 16 A top plan view of the part shown in FIG. 15;

FIG. 17 A control block diagram of the automatic bread maker of the first embodiment;

FIG. 18 An overall flow chart showing processes in a first example of bread making process performed by the automatic bread maker of the first embodiment;

FIG. 19 A flow chart showing a pre-grinding soaking process in the first example of bread making process;

FIG. 20 A flow chart showing a grinding process in the first example of bread making process;

FIG. 21 A flow chart showing a kneading process in the first example of bread making process;

FIG. 22 A flow chart showing a fermentation process in the first example of bread making process;

FIG. 23 A flow chart showing a baking process in the first example of bread making process;

FIG. 24A A graph showing a first control example of a blade rotation shaft performed by a control device incorporated in the automatic bread maker of the first embodiment;

FIG. 24B A graph showing a second control example of a blade rotation shaft performed by a control device incorporated in the automatic bread maker of the first embodiment;

FIG. 24C A graph showing a third control example of a blade rotation shaft performed by a control device incorporated in the automatic bread maker of the first embodiment;

FIG. 25 An overall flow chart showing processes in a second example of bread making process performed by the automatic bread maker of the first embodiment;

FIG. 26 A flow chart showing a post-grinding soaking process in the second example of bread making process;

FIG. 27 An overall flow chart showing processes in a third example of bread making process performed by the automatic bread maker of the first embodiment;

FIG. 28 An overall flow chart showing processes in a fourth example of bread making process performed by the automatic bread maker of the first embodiment; and

FIG. 29 A vertical sectional view showing a bread container according to a second embodiment of the present invention in a situation similar to the situation shown in FIG. 14.

### DESCRIPTION OF EMBODIMENTS

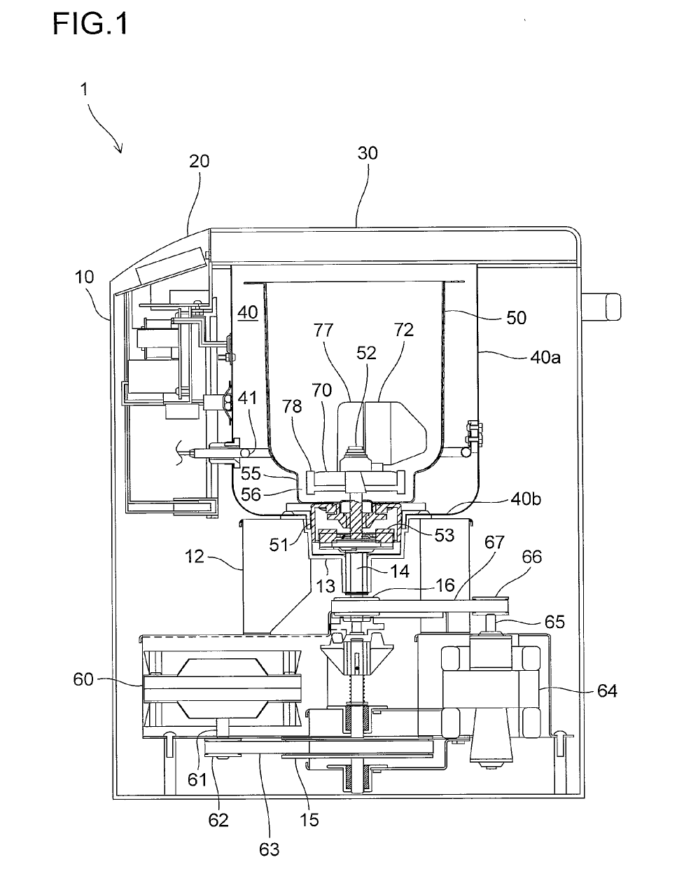

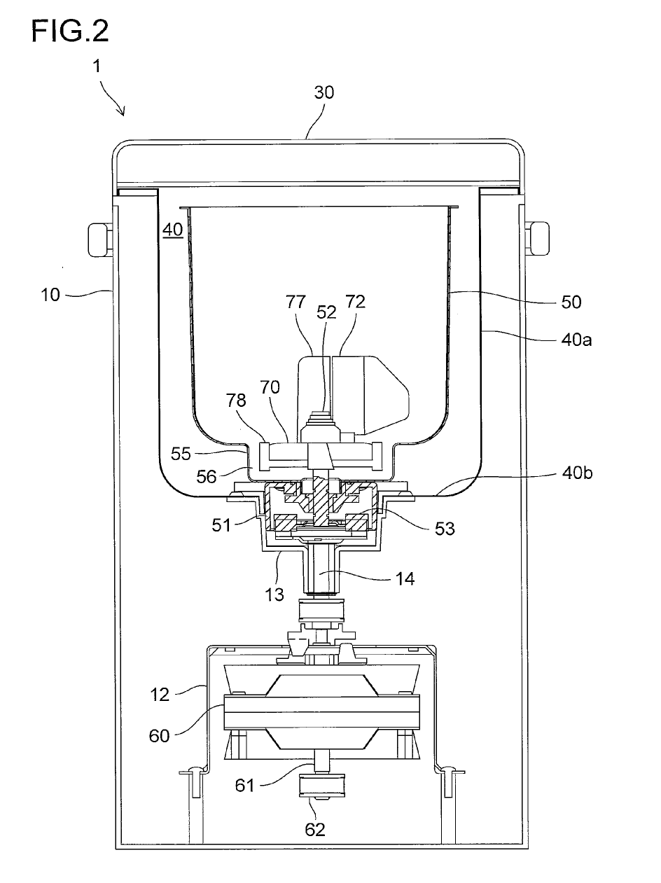

Hereinafter, embodiments of the present invention will be described with reference to the drawings. In FIG. 1, the left side is the front (facade) side of the automatic baking machine 1, and the right side is the rear (back) side of the same. The left-hand side and the right-hand side of an observer facing the front of the automatic bread maker 1 are the left side and the right side, respectively, of the automatic bread maker 1.

The automatic bread maker 1 has a box-shaped body 10 formed with an outer shell made of a synthetic resin. An operation portion 20 is provided in a front portion of an upper surface of the body 10. Although not illustrated in the figures, the operation portion 20 is provided with: a group of operation keys such as a key for selecting the type of bread (wheat flour bread, rice flour bread, bread with optional ingredients, etc.), a cooking program selection key, a timer key, a start key, and a cancellation key; and a display portion that displays a description of a set cooking program and time set through the timer key. The display portion is formed with a liquid crystal display panel and a display lamp including a light emitting diode as its light source.

A portion of the top surface of the body behind the operation portion 20 is covered with a lid 30 made of a synthetic resin. The lid 30 is hinged to a rear edge of the body 10 with an unillustrated hinge shaft, and swings around the hinge shaft within a vertical plane.

Inside the body 10, a baking chamber 40 is provided. The baking chamber 40 is made of a sheet metal and has an open top, through which the bread container 50 is put into the baking chamber 40. The baking chamber 40 has a peripheral side wall 40a which is rectangular in horizontal section and a bottom wall 40b.

Inside the body 10, a base 12 made of a sheet metal is placed. On the base 12, there is fixed a bread container support portion 13, which is made of an aluminum alloy by die casting, to a position corresponding to a position in the center of the baking chamber 40. An inside of the bread container support portion 13 is exposed to an inside of the baking chamber 40.

At a position in the center of the bread container support portion 13, a drive shaft 14 is vertically supported. Pulleys 15, 16 impart rotation to the drive shaft 14. Clutches are arranged one between the pulley 15 and the drive shaft 14 and one between the pulley 16 and the drive shaft 14. Thus, when the pulley 15 is made to rotate in a direction to transmit rotation to the drive shaft 14, the rotation of the drive shaft 14 is not transmitted to the pulley 16, while, when the pulley 16 is made to rotate in a direction opposite to the direction in which the pulley 15 is made to rotate, to transmit rotation to the drive shaft 14, the rotation of the drive shaft 14 is not transmitted to the pulley 15.

The pulley 15 is made to rotate by a kneading motor 60 supported by the base 12. The kneading motor 60 has a vertical shaft, and has an output shaft 61 protruding from a lower surface thereof. To the output shaft 61, there is fixed a pulley 62 which is coupled to the pulley 15 via a belt 63. The kneading motor 60 itself is a low-speed, high-torque motor, and moreover, the pulley 62 makes the pulley 15 rotate at a reduced speed; thus, the drive shaft 14 rotates at a low speed and with a high torque.

The pulley 16 is made to rotate by a grinding motor 64 that is also supported by the base 12. The grinding motor 64 also has a vertical shaft, and has an output shaft 65 protruding from an upper surface thereof. To the output shaft 65, there is fixed a pulley 66 which is coupled to the pulley 16 by a belt 67. The grinding motor 64 plays a role of imparting high-speed rotation to a grinding blade which will be described later. Thus, a high-speed rotation motor is chosen as the grinding motor 64, and the speed reduction ratio between the pulley 66 and the pulley 16 is set approximately to 1:1.

The bread container support portion 13 receives a cylindrical pedestal 51 which is fixed to a bottom surface of the bread container 50, and thereby supports the bread container 50. The pedestal 51 is also made of an aluminum alloy by die casting.

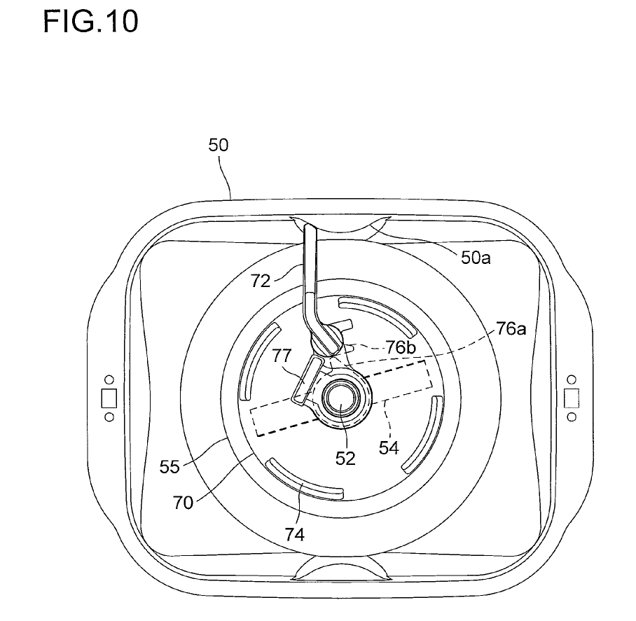

The bread container 50 is made of a metal sheet in a bucket-like shape and provided with a carrying handle (not shown) attached to a rim of an opening thereof. The horizontal section of the bread container 50 is a rectangle with rounded corners. As shown in FIG. 10, on an inner side wall of the bread container 50, a vertically-extending ridge-like protrusion 50a is formed at a position in a center of each of two surfaces of the inner side wall corresponding to the longer sides of the rectangle. The protrusions 50a are provided to promote kneading.

The bread container 50 and the pedestal 51 may be built as a combination of separately molded components as described above, or can be integrally formed by, for example, die-casting.

At a position in the center of a bottom portion of the bread container 50, a blade rotation shaft 52 is vertically supported, with sealing applied thereto. To the blade rotation shaft 52, a rotational force is transmitted from the drive shaft 14 via a coupling 53. The coupling 53 is formed of two members, one of which is fixed to a lower end of the blade rotation shaft 52 and the other of which is fixed to an upper end of the drive shaft 14. The coupling 53 is completely enclosed by the pedestal 51 and the bread container support portion 13.

Unillustrated protrusions are formed on an inner peripheral surface of the bread container support portion 13 and on an outer peripheral surface of the pedestal 51. These protrusions form a known bayonet coupling. Specifically, in attaching the bread container 50 to the bread container support portion 13, the bread container 50 is brought down such that the protrusions of the pedestal 51 do not interfere with the protrusions of the bread container support portion 13. Then, after the pedestal 51 is fitted into the bread container support portion 13, the bread container 50 is horizontally turned, so that the protrusions of the pedestal 51 are engaged under the protrusions of the bread container support portion 13, as a result of which the bread container 50 is fixed such that it cannot be pulled out upward. This operation also accomplishes coupling of the coupling 53. The bread container 50 is twisted, when being set, in the same direction as the rotation direction of a kneading blade which will be described later, so that rotation of the kneading blade does not cause the bread container 50 to come off.

A heating device 41 placed inside the baking chamber 40 surrounds the bread container 50 and applies heat to bread ingredients. The heating device 41 is formed with a sheath heater.

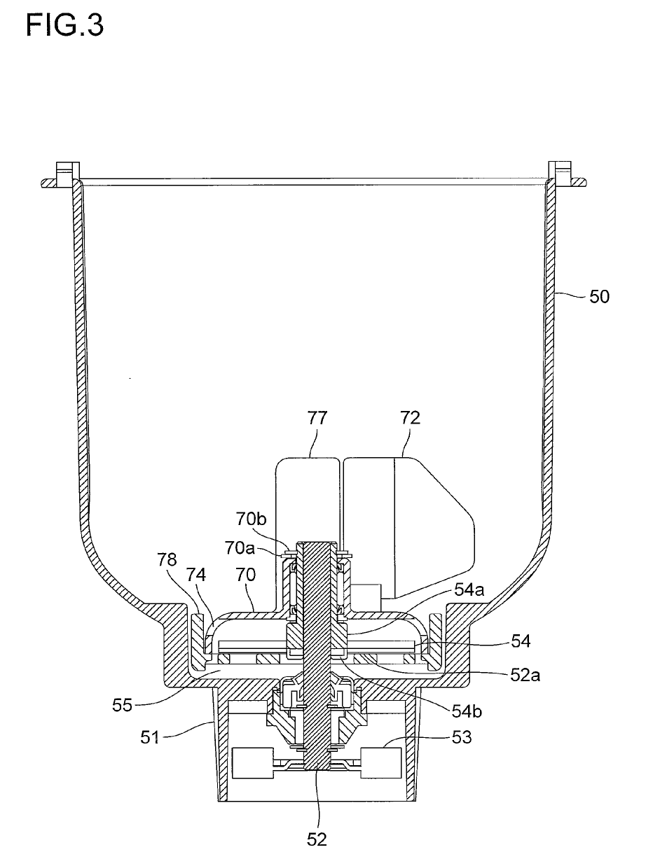

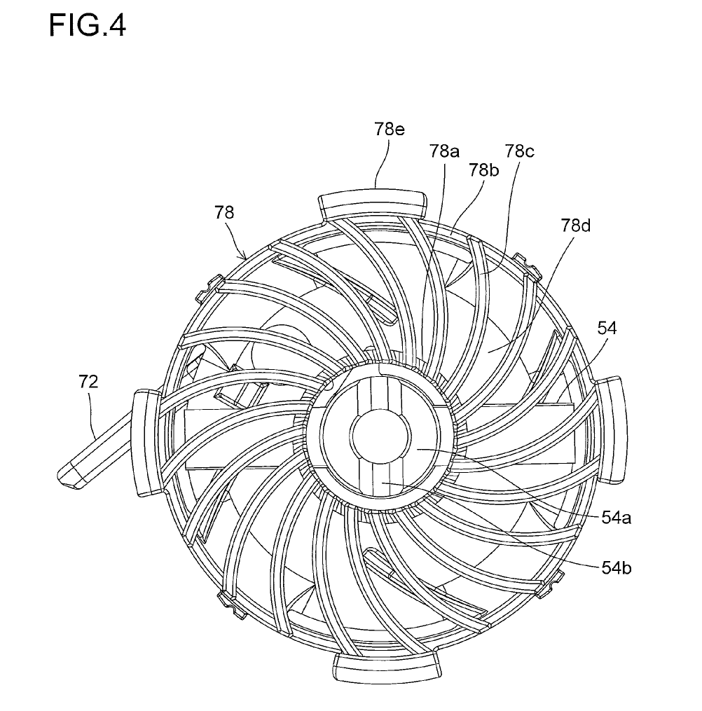

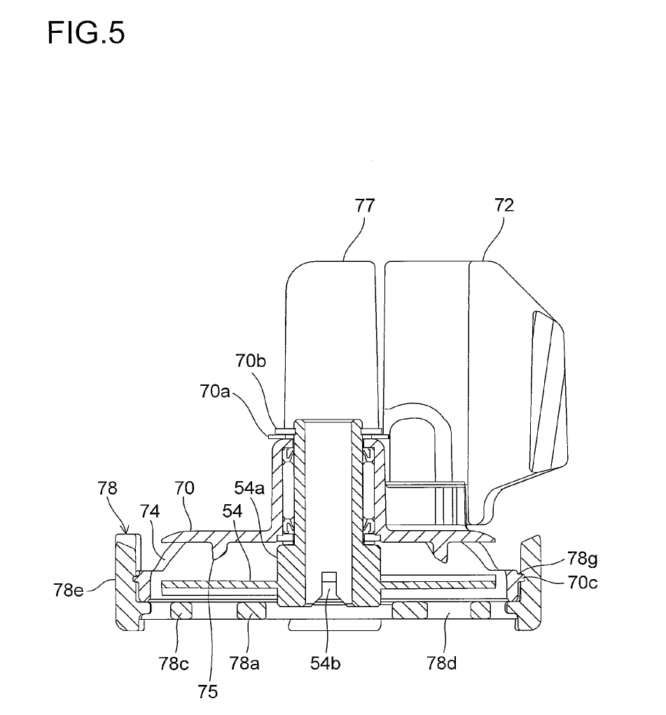

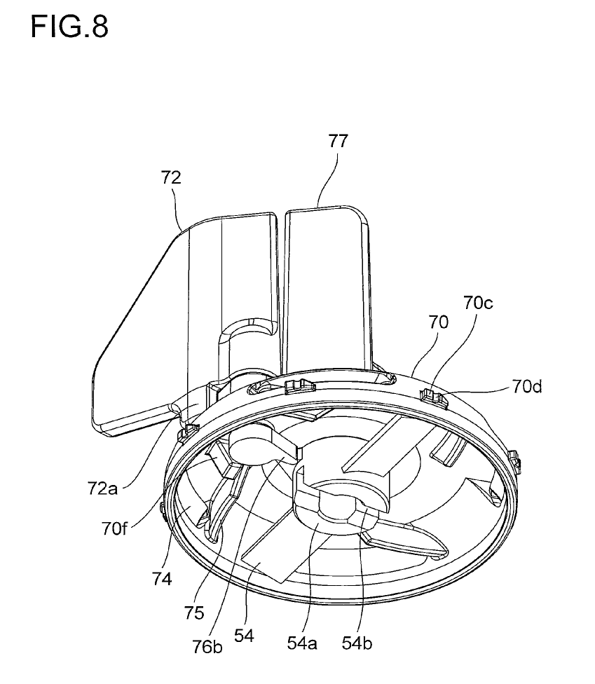

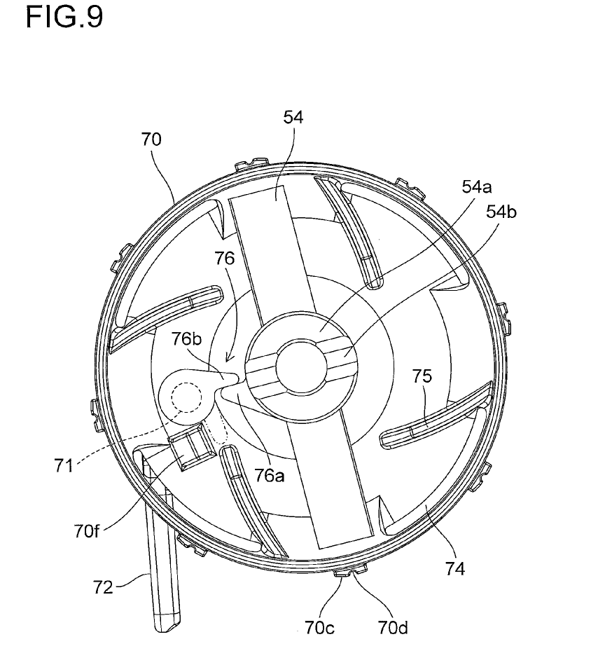

The blade rotation shaft 52 has a grinding blade 54 (see FIG. 3) attached thereto at a position slightly above the bottom portion of the bread container 50. The grinding blade 54 is unrotatable with respect to the blade rotation shaft 52. The grinding blade 54 is made of stainless steel, and as shown in FIGS. 8 and 9, shaped like a propeller of an airplane.

A center portion of the grinding blade 54 is formed as a hub 54a that is fitted to the blade rotation shaft 52. In a lower surface of the hub 54a, a groove 54b is formed across the hub 54a in a diameter direction thereof. A pin 52a horizontally penetrating the blade rotation shaft 52 receives the hub 54a and engages with the groove 54b. Thereby, the grinding blade 54 is coupled such that it is unrotatable with respect to the blade rotation shaft 52. The grinding blade 54 is able to be easily detached from the blade rotation shaft 52, and this facilitates cleaning after a bread making operation and replacement of a dull grinding blade 54 with a new one.

To an upper end of the blade rotating shaft 52, a dome-shaped cover 70 having a circular shape in plan view is fitted. The cover 70 is made of an aluminum alloy by die casting, and covers up the grinding blade 54. The cover 70 is rotatably supported by the hub 54a of the grinding blade 54, and is prevented from coming off from the hub 54a by a washer 70a and a stopper ring 70b. That is, in this embodiment, the grinding blade 54 and the cover 70 form an inseparable unit, and the hub 54a of the grinding blade 54 also functions as a blade rotation blade receiving portion of the cover 70. The cover 70, together with the grinding blade 54, can be easily detached from the blade rotation shaft 52, and this facilitates washing after a bread making operation.

A kneading blade 72 (an embodiment of the first kneading blade of the present invention) having a “<” shape in plan view is attached to an outer surface of the cover 70 via a vertical support shaft 71 (see FIG. 9) disposed at a place away from the blade rotation shaft 52. The kneading blade 72 is also made of an aluminum alloy by die casting. The support shaft 71 is fixed to, or integrally formed with, the mixing blade 72, and moves with the mixing blade 72.

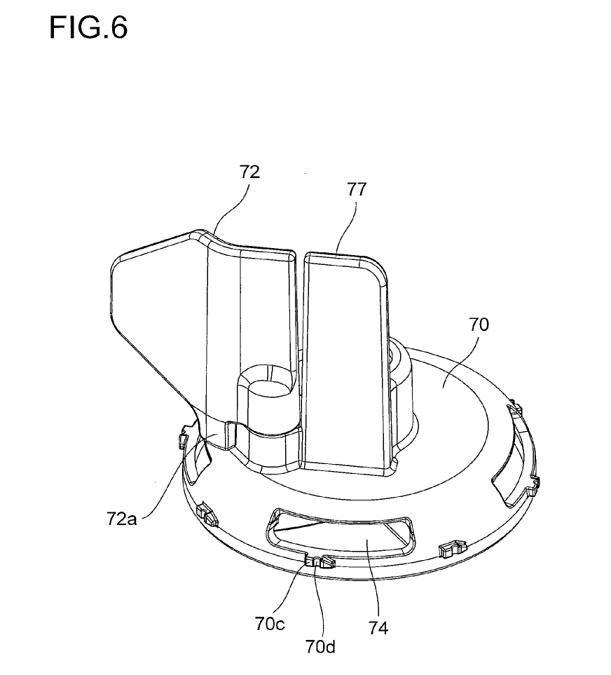

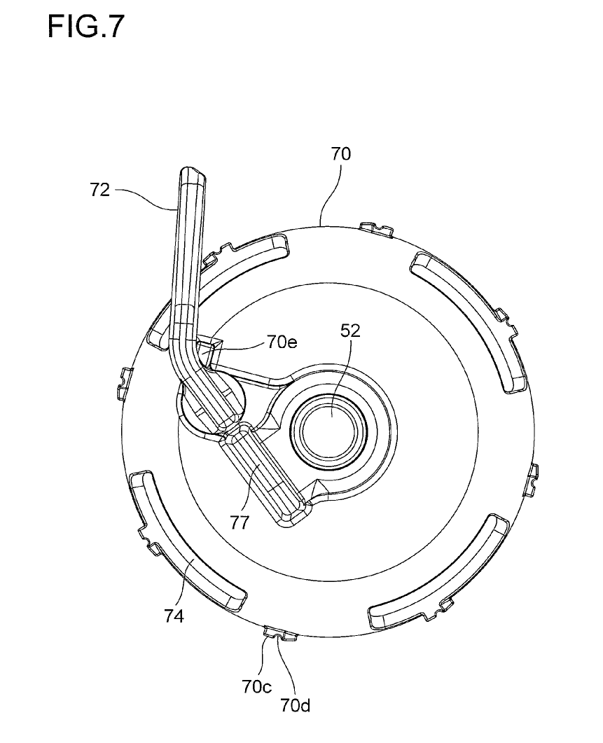

The kneading blade 72 rotates, together with the support shaft 71, around an axis of the support shaft 71, and takes two postures, namely, a folded posture shown in FIGS. 6 to 9 and an open posture shown in FIG. 10. In the folded posture, a protrusion 72a (see FIG. 6) hanging down from a lower edge of the kneading blade 72 is in contact with a stopper portion 70e (see FIG. 7) provided on an upper surface of the cover 70. Thus, in the folded posture, the kneading blade 72 cannot rotate further clockwise (as seen from above) with respect to the cover 70. In this state, a small part of an end portion of the kneading blade 72 protrudes from the cover 70. When the kneading blade 72 rotates counterclockwise (as seen from above) from this posture into the open posture as shown in FIG. 10, a large part of the end portion of the kneading blade 72 protrudes from the cover 70.

In the cover 70, there is formed a window 74 through which a space inside the cover and a space outside the cover communicate with each other. The window 74 is located as high as, or above, the grinding blade 54. In this embodiment, four windows are formed as the window 74 to be arranged at intervals of 90°, but this is not meant to limit the number or intervals of the windows 74.

As shown in FIGS. 8 and 9, on an inner surface of the cover 70, a total of four ribs 75 are formed corresponding to the windows 74 on a one-to-one basis. Each of the ribs 75 extends obliquely with respect to a radius direction of the cover 70 from near a center of the cover 70 to a circumferential annular wall of the cover 70, the four ribs 75 being arranged in a kind of tomoe-formation (a formation that looks like a fan impeller). Furthermore, the ribs 75 are each curved such that a side thereof which faces the bread ingredients rushing thereto is convex.

A clutch 76 (see FIG. 9) is provided between the cover 70 and the blade rotation shaft 52. The clutch 76 couples the cover 70 to the blade rotation shaft 52 in a direction in which the blade rotation shaft 52 rotates when the kneading motor 60 makes the drive shaft 14 rotate (hereinafter, rotation in this direction will be referred to as “forward rotation”; in FIG. 9, the forward rotation is a clockwise rotation). On the other hand, in a direction in which the blade rotation shaft 52 rotates when the grinding motor 64 makes the drive shaft 14 rotate (hereinafter, rotation in this direction will be referred to as “backward rotation”; in FIG. 9, the backward rotation is a counterclockwise rotation), the clutch 76 uncouples the cover 70 from the blade rotation shaft 52. Incidentally, in FIG. 10, the “forward rotation” is a counterclockwise rotation and the “backward rotation” is a clockwise rotation.

The clutch 76 is composed of a first engagement body 76a and a second engagement body 76b. The first engagement body 76a is fixed to, or integrally formed with, the hub 54a of the grinding blade 54. That is, the first engagement body 76a is unrotatably attached to the blade rotation shaft 52. The second engagement body 76b is fixed to, or integrally formed with, the support shaft 71 of the kneading blade 72, and changes its angle as the posture of the kneading blade 72 is shifted.

The clutch 76 changes its coupling state according to the posture of the kneading blade 72. Specifically, when the kneading blade 72 is in the folded posture, the second engagement body 76b is at the angle shown in FIG. 9. At this time, the second engagement body 76b interferes with the rotation path of the first engagement body 76a. Thus, when the blade rotation shaft 52 rotates clockwise in FIG. 9, in other words, rotates forward, the first engagement body 76a engages with the second engagement body 76b, and the rotational force of the blade rotation shaft 52 is transmitted to the cover 70 and the kneading blade 72. When the kneading blade 72 is in the open posture, the second engagement body 76b is at an angle shown in FIG. 10. At this time, the second engagement body 76b is withdrawn from the rotation path of the first engagement body 76a. Thus, when the blade rotation shaft 52 rotates clockwise in FIG. 10, in other words, rotates backward, no engagement occurs between the first engagement body 76a and the second engagement body 76b. Consequently, the rotational force of the blade rotation shaft 52 is not transmitted to the cover 70 and the kneading blade 72.

An opening angle of the kneading blade 72 is limited by a stopper portion 70f (see FIG. 8 and FIG. 9) formed on the inner surface of the cover. That is, the opening angle of the kneading blade 72 is the largest when the second engagement body 76b is in contact with the stopper portion 70f.

On the outer surface of the cover 70, an auxiliary kneading blade 77 is formed beside the kneading blade 72. The auxiliary kneading blade 77 is aligned with the kneading blade 72 in the folded posture. That is, when the kneading blade 77 is in the folded posture, the auxiliary kneading blade 77 is so positioned as to extend from an end of the kneading blade 72, such that they together form a “<” shape similar to, but larger than, the “<” shape of the kneading blade 72.

In a bottom portion of the bread container 50, there is formed a recess 55 which accommodates the grinding blade 54 and the cover 70. The recess 55 is circular in plan view, and between an outer peripheral portion of the cover 70 and an inner surface of the recess 55, there is formed a clearance 56 that allows passage of the bread ingredients therethrough.

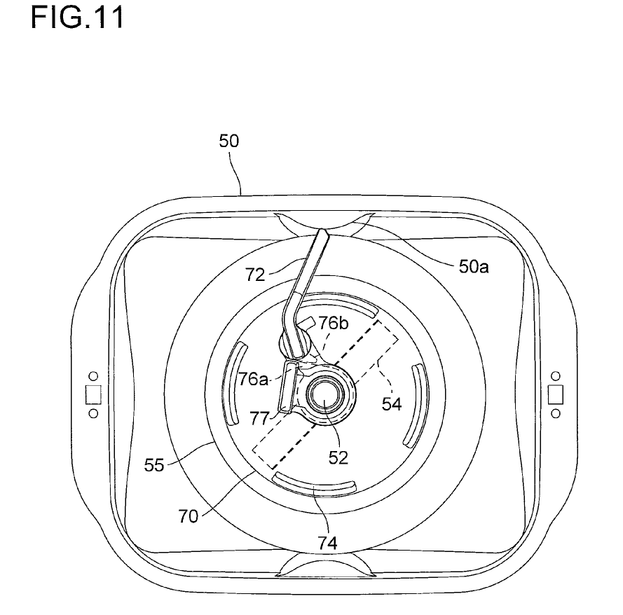

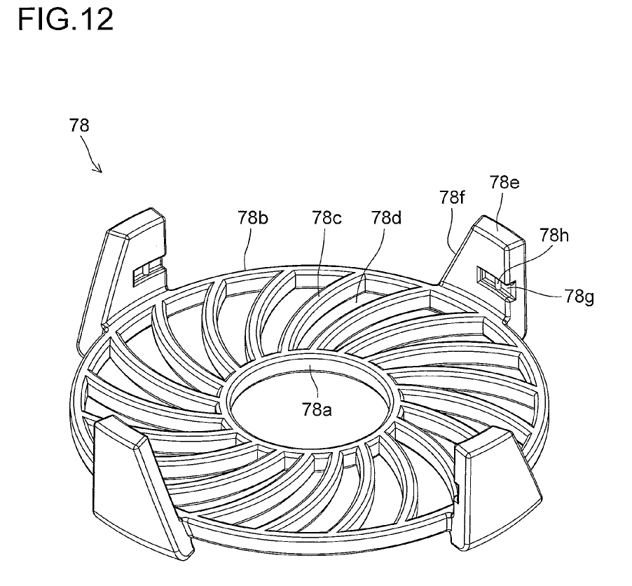

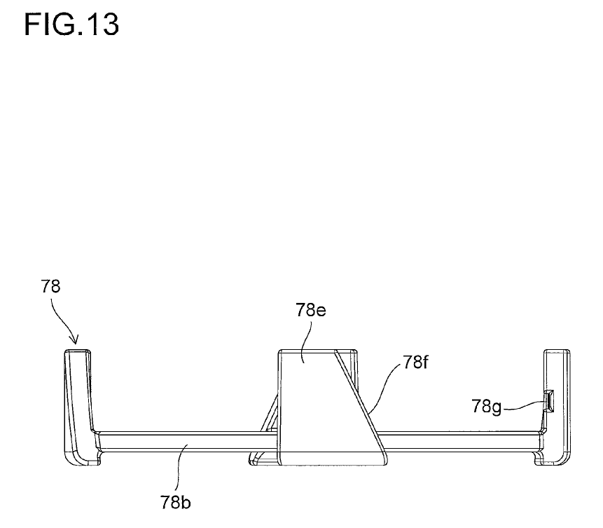

To the cover 70, a guard 78 is detachably attached to cover a lower surface of the cover 70, to stop human fingers from approaching the grinding blade 54. The guard 78 is structured as shown in FIG. 12. Specifically, a ring-shaped hub 78a through which the blade rotation shaft 52 is put is formed in the center, and a ring-shaped rim 78b is formed at the periphery. A plurality of spokes 78c couple the hub 78a and the rim 78b. A space between any adjacent ones of the spokes 78c are openings 78d for allowing passage therethrough of cereal grains which are ground by the grinding blade 54. The openings 78d are each formed small enough to prevent fingers from passing therethrough.

When attached to the cover 70, the guard 78 is close to the grinding blade 54 to an extent, specifically, that the spokes 78c and the grinding blade 54 do not contact with each other. As a result, the guard 78 and the grinding blade 54 look as if the guard 78 and the grinding blade 54 are an outer blade and an inner blade, respectively, of an electric rotary shaver.

Each of the spokes 78c extends not in a straight line along a radius of the guard 78, but such that, when the blade rotation shaft 52 rotates forward (counterclockwise as seen from above) and the cover 70 and the guard 78 also rotate forward, each of the spokes 78c moves such that a portion thereof close to the center of the guard 78 moves ahead of (passes a standard diameter line earlier than) a portion thereof close to the periphery of the guard 78, which moves behind (passes the standard diameter line later than) the portion close to the center of the guard 78. In this embodiment, the spokes 78c are curved, but they may be straight instead.

At the periphery of the guard 78, a plurality of columns 78e are integrally formed with the rim 78b at a predetermined angular intervals. In this embodiment, a total of four columns 78e are arranged at intervals of 90°. A side surface 78f of each of the columns 78e is inclined to face upward, the side surface 78f being a front surface of each of the columns 78e in the rotation direction of the blade rotation shaft 52 when it rotates forward. A lower end of each of the columns 78e protrudes below the spokes 78c.

The columns 78e also serve to couple the guard 78 to the cover 70. The columns 78e each have a horizontal groove 78g formed in a side surface thereof facing to the center of the guard, one end of the groove 78g being formed as a dead end. Corresponding to the grooves 78g, protrusions 70c are formed on an outer periphery of the cover to engage with the grooves 78g. In this embodiment, a total of eight protrusions 70c are arranged at intervals of 45°.

The grooves 78g and the protrusions 70c form a known bayonet coupling. A direction in which the guard 78 is twisted to engage the grooves 78g and the protrusions 70c with each other is the same as the direction of the backward rotation of the blade rotation shaft 52. Thus, even when the cover 70 rotates forward for kneading, the guard 78 does not come off from the cover 70.

When the blade rotation shaft 52 is made to rotate backward for the grinding blade 54 to grind cereal grains, the cereal grains and the liquid flow, to apply pressure to the guard 78. The pressure application direction is the same as the direction in which the guard 78 is twisted to be attached, and thus, at this time as well, the guard 78 does not come off from the cover 70.

For the purpose of preventing the guard 78 from coming off from the cover 70 too easily, a mechanism for generating resistance against the twist in a direction for detaching the guard 78 is provided between the columns 78e and the cover 70. Specifically, inside each of the grooves 78g, a protrusion 78h is formed to vertically extend like a ridge, and in each of the protrusions 70c, a recess 70d is formed in which the protrusion 78h is engaged. At a final stage of the twisting for attaching the guard 78, the projection 78h is elastically engaged into the recess 70d. As a result, predetermined resistance is generated against twist in the direction for detaching the guard 78.

The guard 78 is molded by using a heat-resistant engineering plastic such as polyphenylene sulfide (PPS).

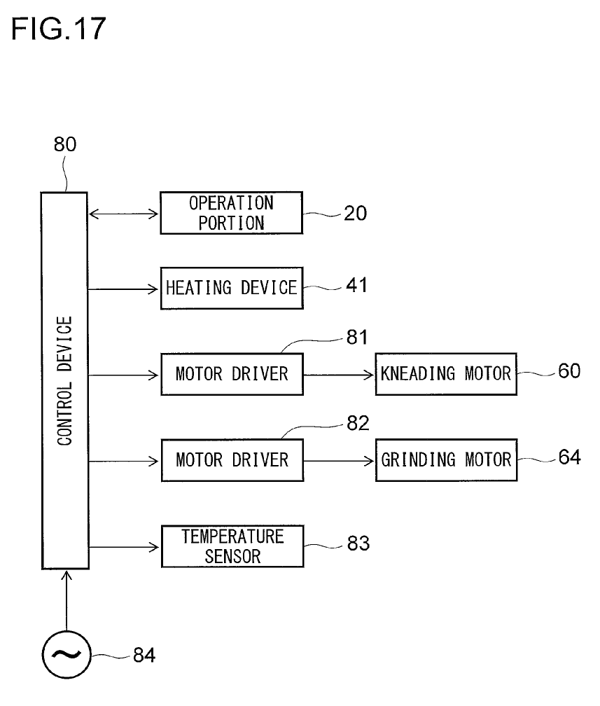

Operation of the automatic bread maker 1 is controlled by a control device 80 shown in FIG. 17. The control device 80 is formed of a circuit board appropriately located within the body 10 (preferably at a place where it is least affected by heat from the baking chamber 40). The control device 80 is connected to the operation portion 20 and the heating device 41, and further, to a motor driver 81 of the kneading motor 60, a motor driver 82 of the grinding motor 64, and a temperature sensor 83. The temperature sensor 83 is disposed inside the baking chamber 40, and measures the temperature of the baking chamber 40. Reference numeral 84 denotes a commercial power supply that supplies power to each component.

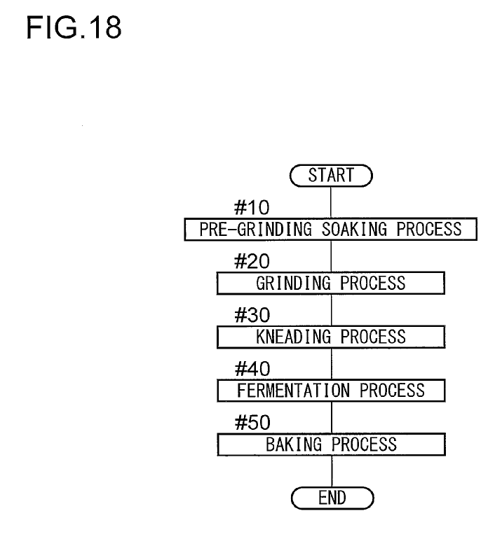

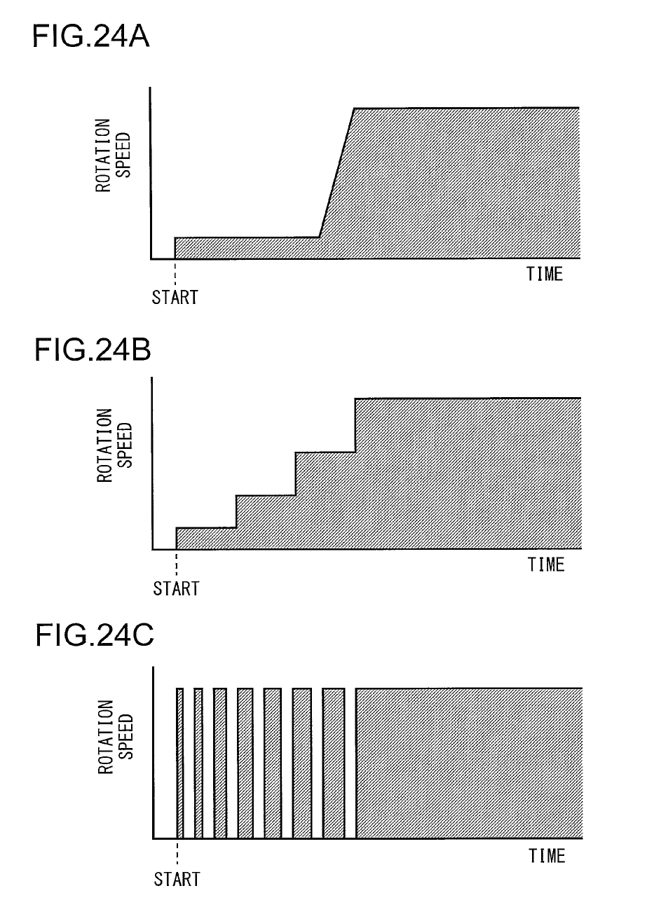

Next, a description will be given of a process of making bread from cereal grains by using the automatic bread maker 1, with reference to FIGS. 18 to 27. Drawings from FIG. 18 to FIG. 24 (FIG. 24A, FIG. 24B, FIG. 24C) show a first example of bread making process.

Before starting the bread making process, a user needs to make the automatic bread maker 1 ready for use. As already described, the grinding blade 54 and the cover 70 form an inseparable unit. In attaching the unit combined with the guard 78 to the blade rotation shaft 52, the guard 78 stops the fingers of the user from approaching the grinding blade 54, and thus the user is protected from the risk of his/her fingers touching the grinding blade 54 to be injured.

FIG. 18 is an overall flow chart of the first example of bread making process. In FIG. 18, a pre-grinding soaking process #10, a grinding process #20, a kneading process #30, a fermentation process #40, and a baking process #50 are performed in this order. Next, descriptions will be given of the processes.

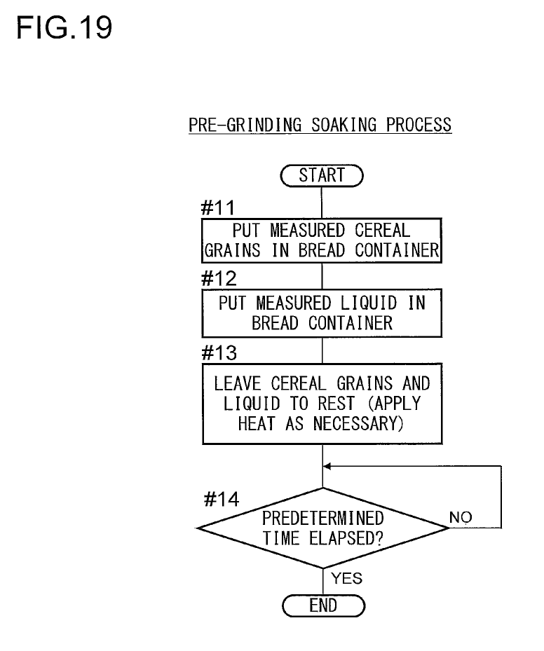

The pre-grinding soaking process #10 shown in FIG. 19 starts with step #11 where the user measures cereal grains and puts a certain amount of cereal grains in the bread container 50. As the cereal grains, rice is the most available, but grains of other cereals such as wheat, barley, foxtail millet, Japanese barnyard millet, buckwheat (soba), and corn may be used.

In step #12, the user measures liquid and puts a certain amount of liquid in the bread container 50. The liquid is typically water, but it may be a soup stock which contains a taste component, or it may be fruit juice. Further, this liquid may contain alcohol. Step #11 and step #12 may be performed in a reverse order.

The cereal grains and the liquid may be put in the bread container 50 with the bread container 50 placed outside or inside the baking chamber 40.

After putting the cereal grains and the liquid into the bread container 50 placed inside the baking chamber 40, or after attaching the bread container 50 into which the cereal grains and the liquid have been put outside the baking chamber 40 to the bread container support portion 13, the user closes the lid 30. Here, the user presses a predetermined operation key of the operation portion 20 to start counting how long the cereal grains are soaked in the liquid. At this time point, step #13 starts.

In step #13, a mixture of the cereal grains and the liquid is left to rest in the bread container 50, so that the liquid soaks into the cereal grains. Generally, the higher the liquid temperature is, the faster the cereal grains absorb the liquid, and thus the heating device 41 may be energized to raise the temperature of the baking chamber 40.

In step #14, the control device 80 checks how long the cereal grains and the liquid have been left to rest. The pre-grinding soaking process #10 finishes when the cereal grains and the liquid are found to have been left to rest for a predetermined period of time. This is informed to the user via a display on the operation portion 20, via sound, etc.

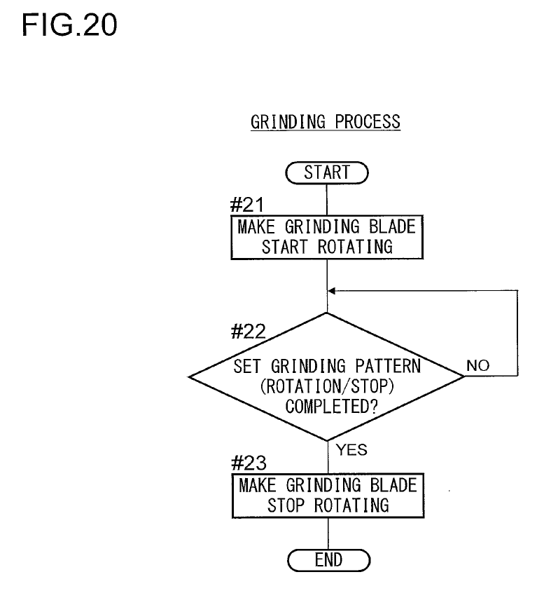

Following the pre-grinding soaking process #10, the grinding process #20 shown in FIG. 20 is performed. When the user inputs grinding operation data (kind and amount of cereal grains, kind of bread to be baked, etc.) through the operation portion 20 and presses the start key, step #21 starts to be performed.

In step #21, the control device 80 drives the grinding motor 64, to make the blade rotation shaft 52 rotate backward. Then, the grinding blade 54 starts rotating in the mixture of the cereal grains and the liquid. The cover 70 also follows the blade rotation shaft 52 to start rotating. The direction in which the cover 70 rotates at this time is clockwise in FIG. 10, and the kneading blade 72, when it is in the folded posture, moves into the open posture on receiving resistance from the mixture of the cereal grains and the liquid. When the kneading blade 72 has moved into the open posture, the second engagement body 76b withdraws from a rotation path of the first engagement body 76a. Thereby, the clutch 76 uncouples the blade rotation shaft 52 and the cover 70 from each other. At the same time, the kneading blade 72 in the open posture comes into contact with one of the protrusions 50a on the inner wall of the bread container 50 as shown in FIG. 10, to prevent the cover 70 from rotating. Thereafter, the blade rotation shaft 52 and the grinding blade 54 rotate backward at high speed.

When the blade rotation shaft 52 rotates backward, the kneading blade 72 sometimes comes into contact with the protrusions 50a in an incomplete open posture. The kneading blade 72 in this state is shown in FIG. 11. In this embodiment, a rotation radius from a center of the support shaft 71 to an end of the kneading blade 72 is set such that the kneading blade 72, when it has come into contact with either one of the protrusions 50a in the incomplete open posture, can rotate past the point where it has come into contact with the protrusion 50a, keeping its incomplete open posture. That is, thereafter, the kneading blade 72 shown in FIG. 11 rotates past the protrusion 50a. As a result, the kneading blade 72 does not receive an undesired force before it moves into the open posture to stop rotating, and thus the rotation system, from the kneading blade 72 to the grinding motor 64, is not forced to stop, which helps prevent occurrence of, for example, burnout of the grinding motor 64. After moving past the protrusion 50a illustrated in an upper part of FIG. 11, the kneading blade 72 moves into the complete open posture by the time it reaches the protrusion 50a illustrated in a lower part of FIG. 11, and thus what has happened with respect to the protrusion 50a illustrated in the upper part of FIG. 11 is not repeated with respect to the protrusion 50a illustrated in the lower part of FIG. 11.

Since the kneading blade 72 comes into contact with the protrusion 50a, as described above, to make the cover 70 and the kneading blade 72 stop rotating, even when the grinding blade 54 rotates at high speed, the mixture of the cereal grains and the liquid does not swirl inside the bread container 50. Thus, no swirl of the mixture of the cereal grains and the liquid rises up along the periphery of the bread container 50 to flow out of the bread container 50.

While the kneading blade is in contact with the protrusion 50a and thus the cover 70 is not rotating, the guard 78 is not rotating, either. When moving into the cover 70 through the openings 78d of the guard 78, cereal grains are sheared between the stationary spokes 78c and the rotating grinding blade 54, which helps improve the grinding performance.

Since the cereal grains are ground by the grinding blade 54 after the liquid has soaked into them, it is easy to grind them to their cores. The ribs 75, each extending from near the center of the cover 70 to the circumferential annular wall of the cover 70, assist the grinding by reducing the flow of the mixture of the cereal grains and the liquid in the same direction as the rotation direction of the grinding blade 54. That is, the ribs 75 change the flow of the mixture to increase the chances for the cereal grains to hit against the grinding blade 54. Since the grinding is performed inside the cover 70, the cereal grains are prevented from scattering outside the bread container 50.

The mixture of the ground cereal grains and the liquid is guided by the ribs 75 toward the windows 74, through which the mixture is discharged out of the cover 70. Also, since each of the ribs 75 is curved to protrude on the side thereof which faces the mixture of the cereal grains and the liquid when it rushes thereto, the mixture of the cereal grains and the liquid is less likely to stay on the surface of each of the ribs 75 and more likely to flow smoothly toward the windows 74.

When the mixture of the cereal grains and the liquid is discharged out of the cover 70, the mixture of the cereal grains and the liquid present in a space above the recess 55 moves into the recess 55 through the clearance 56, and then moves from the recess 55 into the cover 70 through the openings 78d of the guard 78. The cereal grains are ground by the grinding blade 54 inside the cover 70, and then return to the space above the recess 55. It is possible to grind the cereal grains efficiently by grinding them while making them circulate in this way. As already mentioned, the spokes 78c of the guard 78 help promote the grinding of the cereal grains. The provision of the ribs 75 allows the ground substance produced by the grinding blade 54 to be quickly guided to the windows 74 without remaining inside the cover 70, and this helps further improve the grinding efficiency.

Since the windows 74 are located as high as, or higher than, the grinding blade 53, the mixture of the ground cereal grains and the liquid is discharged out of the cover 70 in a horizontal or obliquely upward direction, and this helps promote the circulation of the cereal grains.

In step #22, the control device 80 checks whether or not the grinding has been completed according to a set grinding pattern (whether the grinding blade is to be continuously rotated or intermittently rotated interspersed with stop periods, how the intervals be set and how long a rotation time period should be in the case of intermittent rotation, etc.).

When the grinding is found to have been completed according to the set grinding pattern, the procedure proceeds to step #23, where the grinding blade 54 is made to stop rotating, and the grinding process #20 is finished. This is informed to the user via a display on the display portion 22, via sound, etc.

In the above descriptions, the grinding process #20 is made to start by the user's operation after the pre-grinding soaking process #10. However, this is not meant as limitation, and the grinding process #20 may be set to automatically start after the pre-grinding soaking process #10 according to grinding operation data inputted by the user either before or in the course of the pre-grinding soaking process #10.

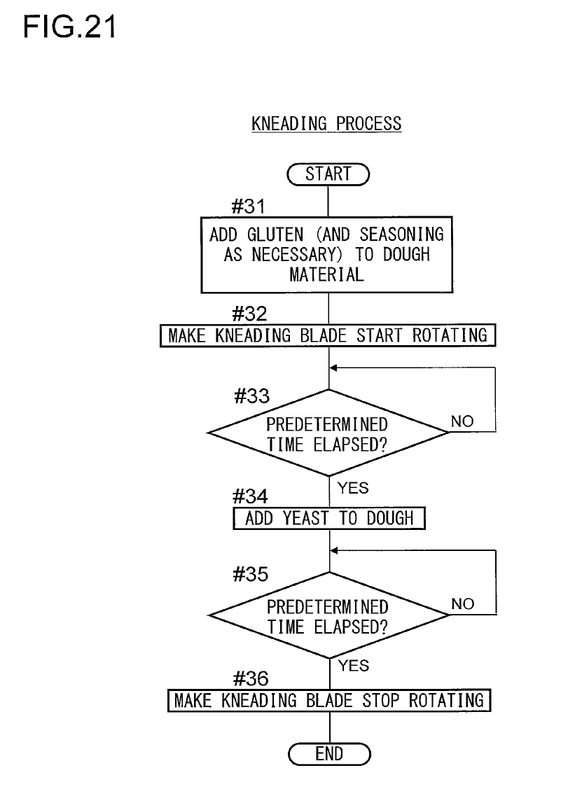

Following the grinding process #20, the kneading process #30 shown in FIG. 21 is performed. At the start of the kneading process #30, the cereal grains and the liquid in the bread container 50 have become a dough material in a pasty or slurry state. Note that, herein, a substance that is present at the start of the kneading process #30 is referred to as “dough material,” while a substance becoming increasingly similar to the aimed dough as the kneading proceeds is referred to as “dough” even before it is completed as dough.

In step #31, the user opens the lid 30 to add a certain amount of gluten to the dough material. A seasoning such as salt, sugar, or shortening is added to the dough material as necessary. It is also possible to provide the automatic bread maker 1 with an automatic feeder for gluten and seasonings to throw them in without bothering the user.

Substantially simultaneously with step #31, the user operates the operation portion 20 to input data of the kind of bread to be baked and of the cooking program to be performed. When the machine is ready, the user presses the start key, to start the bread making operation in which processes are automatically performed in series from the kneading process #30, to the fermentation process #40, and further to the baking process #50.

In step #32, the control device 80 drives the kneading motor 60. When the blade rotation shaft 52 rotates forward, the grinding blade 54 also rotates forward, and, of the dough material, a part present around the grinding blade 54 flows in the forward direction. When the cover 70 is made to move in the forward direction by the part of the dough material flowing in the forward direction, the kneading blade 72 receives resistance from a stationary part of the dough material which is not flowing, and gradually moves to positions at different angles, from the open posture to the folded posture. When the kneading blade 72 has moved to a position at an angle at which the second engagement body 76b interferes with the rotation path of the first engagement body 76a, the clutch 76 is brought into a coupled state, and the cover 70 is ready to be fully driven by the blade rotation shaft 52. The kneading blade 72 is completely in the folded posture. Then, the cover 70 and the kneading blade 72 rotate forward integrally with the blade rotation shaft 52.

When the kneading blade 72 is brought into the folded posture, the auxiliary kneading blade 77 is so positioned as to extend from the kneading blade 72, such that they together form a “<” shape similar to, but larger than, the “<” shape of the kneading blade 72, and press the dough material hard. This helps achieve secure kneading of the dough material.

The guard 78 also rotates forward together with the cover 70. As already mentioned, the spokes 78c are arranged such that each of the spokes 78c rotates in the forward rotation such that the portion thereof close to the center of the guard 78 moves ahead of the portion thereof close to the periphery of the guard 78; thus, when the guard 78 rotates forward, the spokes 78c push the dough material present inside and outside the cover 70 outward. This helps reduce the ratio of dough which, after being baked into bread, is discarded when the cover 70 is removed from the bread.

Furthermore, as already mentioned, the columns 78e of the guard 78 are each formed such that the side surface 78f of each of the columns 78e is inclined to face upward, the side surface 78f being the front surface of each of the columns 78e when the guard 78 rotates forward; thus, in the kneading process, the part of the dough material present around the cover 70 is struck up by the front surface of each of the columns 78e to be combined with the main part of the dough material located above. This helps reduce the amount of dough which is discarded without being united with the baked bread.

In step #32, the control device 80 energizes the heating device 41 to raise the temperature of the baking chamber 40. As the kneading blade 72 and the auxiliary kneading blade 77 rotate, the dough material is kneaded into a lump of dough having predetermined elasticity. The kneading blade 72 and the auxiliary kneading blade 77 swing the dough around and beat it against an inner wall, particularly the protrusion 50a, of the bread container 50, which forms a “kneading” element of the kneading process.

When the cover 70 rotates, the ribs 75 also rotate. When the ribs 75 rotate, the dough material inside the cover 70 is quickly discharged through the windows 74, to be merged with the lump of the dough material kneaded by the kneading blade 72 and the auxiliary kneading blade 77.

In step #33, the control device 80 checks how much time has elapsed since the start of the rotation of the kneading blade 72 and the auxiliary kneading blade 77. When a predetermined period of time is found to have elapsed, the procedure proceeds to step #34.

In step #34, the user opens the lid 30 to add yeast to the dough. The yeast added to the dough here is dry yeast. Instead of yeast, baking powder may be used. Yeast and baking powder may also be automatically fed by an automatic feeder. This helps save the user time and trouble.

In step #35, the control device 80 checks how much time has elapsed after the feeding of yeast to the dough. When a certain period of time necessary to obtain desired dough is found to have elapsed, the control device 80 makes the procedure proceed to step #36, where the kneading blade 72 and the auxiliary kneading blade 77 are made to stop rotating. By this time, a lump of dough having required elasticity is completed. Most of the dough stays above the recess 55, with only a very small part thereof left in the recess 55.

In the case of baking bread with an optional ingredient, at any step in the kneading process #30, the optional ingredient is added. An automatic feeder can be adopted for optional ingredients as well.

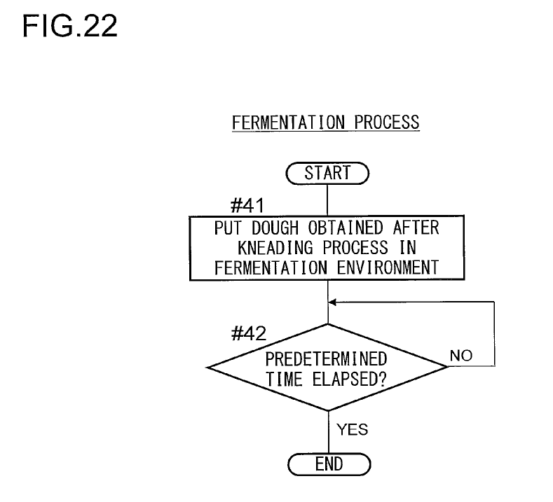

Following the kneading process #30, the fermentation process #40 shown in FIG. 22 is performed. In step #41, dough resulting from the kneading process #30 is placed in a fermentation environment. That is, the control device 80 energizes the heating device 41, if necessary, to thereby raise the temperature of the baking chamber 40 into such a temperature range that helps promote fermentation. The user forms the dough into a desired shape and leaves it to rest as necessary.

In step #42, the control device 80 checks how long the dough has been put in the fermentation environment. When a predetermined period of time is found to have elapsed, the fermentation process #40 is finished.

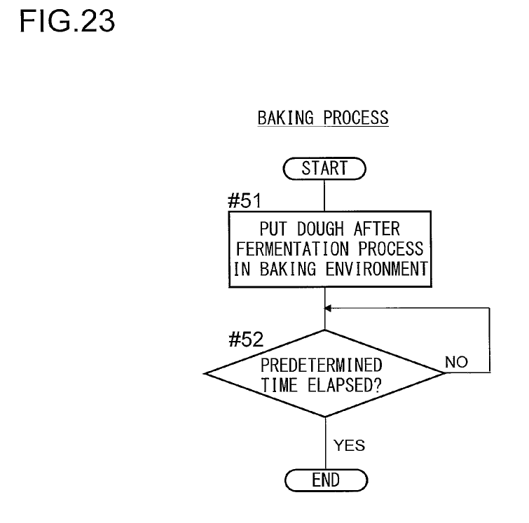

Following the fermentation process #40, the baking process #50 shown in FIG. 23 is performed. In step #51, the dough undergone the fermentation process is put in a baking environment. That is, the control device 80 supplies the heating device 41 with power necessary for baking bread, and thereby raises the temperature of the baking chamber 40 into a temperature range suitable for baking bread.

In step #52, the control device 80 checks how long the dough has been put in the baking environment. When a predetermined period of time is found to have elapsed, the baking process #50 is finished. Here, completion of the bread making is announced via a display on the display portion 22 or via sound, and in response to the announcement, the user opens the lid 30 and takes out the bread container 50 from the baking chamber 40. Then, the user takes bread out of the bread container 50. The kneading blade 72 leaves its trace in the bottom of the bread; however, since the cover 70 and the guard 78 are accommodated in the recess 55 and do not protrude from the bottom of the bread container 50, the cover 70 and the guard 78 are not likely to leave a large trace thereof in the bottom of the bread.

After taking out the bread, the user takes out the unit of the grinding blade 54 and the cover 70 out of the bread container 50. If the guard 78 is removed from the unit and placed, for example, on a platform such as a table top, since the guard 78 is made of a synthetic resin, which is not very heat conductive, the bread taken out of the bread container 50 can be put on the guard 78 to be cooled down.

Since the lower ends of the columns 78e protrude below the spokes 78c, when the guard 78 is put on the platform, the spokes 78c are above the platform, and thus there is formed a space through which air is allowed to flow. This allows fast cooling of the guard 78 and further, of the cover 70 and the grinding blade 54 supported by the guard 78.

The control device 80 controls the rotation of the blade rotation shaft 52 in the following manner. That is, in rotating the blade rotation shaft 52 by using the kneading motor 60 or the grinding motor 64, the control device 80 first makes the blade rotation shaft 52 go through a stage in which the blade rotation shaft 52 rotates at a low speed or intermittently, and then the control device 80 boosts the rotation speed of the motor to a set rotation speed (herein referred to as “rated rotation speed”). The low-speed or intermittent rotation continues for a predetermined period of time. FIGS. 24A, 24B and 24C schematically show how this control is performed, and three control examples are shown in the figures.

In a first control example shown in FIG. 24A, the blade rotation shaft 52 is controlled such that it continues to rotate at a low speed for a predetermined period of time before boosting its rotation speed to the rated rotation speed. When the kneading motor makes the blade rotation shaft 52 rotate forward, the first engagement body 76a of the clutch 76 moves slowly to be engaged with the second engagement body 76b. Accordingly, the cover 70, the kneading blade 72, the auxiliary kneading blade 77, and the guard 78 move slowly at first, and this helps prevent the cereal grains, the liquid, the dough material which is a mixture of ground cereal grains and liquid, and the like from being scattered out of the bread container 50. This also helps lower the initial level of noise and vibration caused by the cover 70, the blade 72, the auxiliary kneading blade 77, and the guard 78. Furthermore, it is also possible to prevent damage of mechanism components such as the clutch 76.

Likewise, when the grinding motor 64 makes the blade rotation shaft 52 rotate backward, the blade rotation shaft 52 rotates at a low speed for a predetermined period of time before it starts to rotate at the rated rotation speed. The kneading blade 72 moves from the folded posture into the open posture, to come into contact with the inner wall of the bread container 50 while rotating at a low speed, and thus less noise and less vibration are caused when the kneading blade 72 hits against the inner wall of the bread container 50. The provision of the low-speed rotation period helps prevent damage of the mechanism components.

In a second control example shown in FIG. 24B, the rotation speed of the blade rotation shaft 52 is raised in a stepwise fashion. The second control example offers the same operation/working-effect as the first control example shown in FIG. 24A.

In a third control example shown in FIG. 24C, the blade rotation shaft 52 first rotates intermittently, and then shifts to continuous rotation. By this control example as well, it is possible to make the cover 70, the kneading blade 72, the auxiliary kneading blade 77, the guard 78, and the grinding blade 54 start their rotation at a moderate speed.

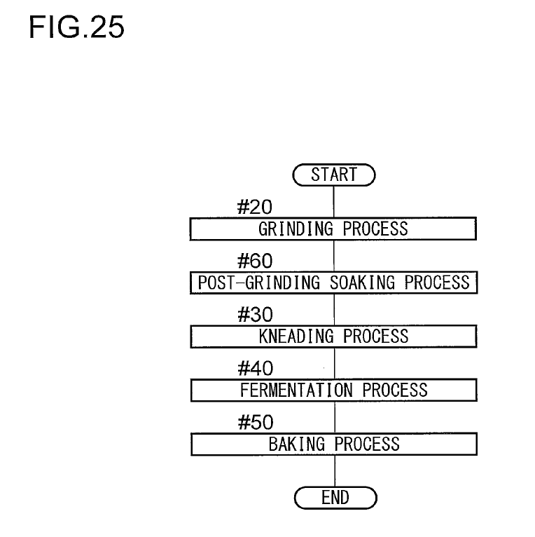

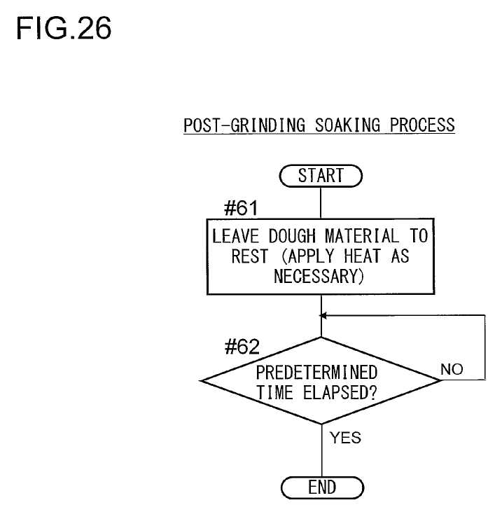

Next, a second example of bread making process will be described based on FIGS. 25 and 26. FIG. 25 is an overall flow chart showing the second example of bread making process. In FIG. 25, a grinding process #20, a post-grinding soaking process #60, a kneading process #30, a fermentation process #40, and a baking process #50 are performed in this order. Now, steps in the post-grinding soaking process #60 will be described based on FIG. 26.

In step #61, dough material formed in the grinding process #20 is left to rest in the bread container 50. The dough material here has not undergone the pre-grinding soaking process. While the dough material is being left to rest, the liquid soaks into the ground cereal grains. The control device 80 energizes the heating device 41 as necessary to apply heat to the dough material to promote the soaking.

In step #62, the control device 80 checks how long the dough material has been left to rest. When a predetermined period of time is found to have elapsed, the post-grinding soaking process #60 is finished. When the post-grinding soaking process #60 is finished, the procedure automatically proceeds to the kneading process #30. The kneading process #30 and processes performed thereafter are the same as in the first example of bread making process.

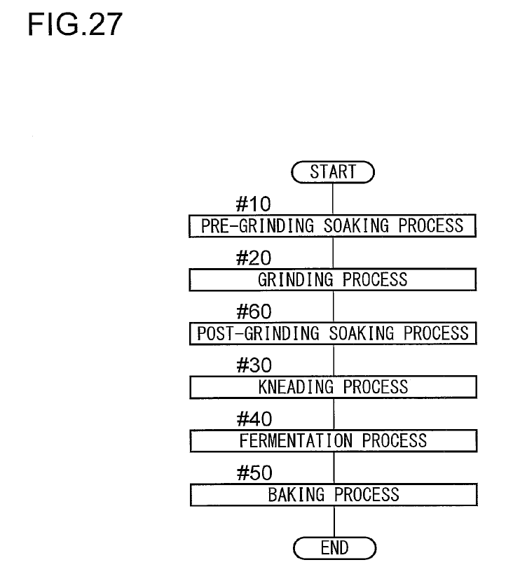

Next, a third example of bread making process will be described based on FIG. 27. FIG. 27 is an overall flow chart showing the third example of bread making process. Here, the pre-grinding soaking process #10 of the first example is performed before a grinding process #20, and the post-grinding soaking process #60 of the second example is performed after the grinding process #20. Then a kneading process 30 is performed; the kneading process 30 and processes performed thereafter are the same as in the first example of bread making process.

The grinding blade 54 can be used not only to grind cereal grains but also to break optional ingredients such as nuts and leaf vegetables into small pieces. This makes it possible to bake bread containing small-particle optional ingredients. The grinding blade 54 can also be used, for example, to grind foodstuff other than optional ingredients for bread, or to grind crude drug materials.

In this embodiment, the single control device 80 is able to control the grinding blade 54 and the kneading blade 72 to rotate in association with each other. Thus, with the automatic bread maker 1, it is possible to impart rotation to the grinding blade 54, the kneading blade 72, and the auxiliary kneading blade 77 according to the kind and the amount of cereal grains in the stage of grinding cereal grains and in the stage of kneading the cereal flour resulting from the grinding, to thereby improve the quality of bread.

The processes described hereinbefore are processes of making bread by grinding cereal grains by using the automatic bread maker 1. Next, a description will be given of processes of making bread by using ready-made cereal flour.

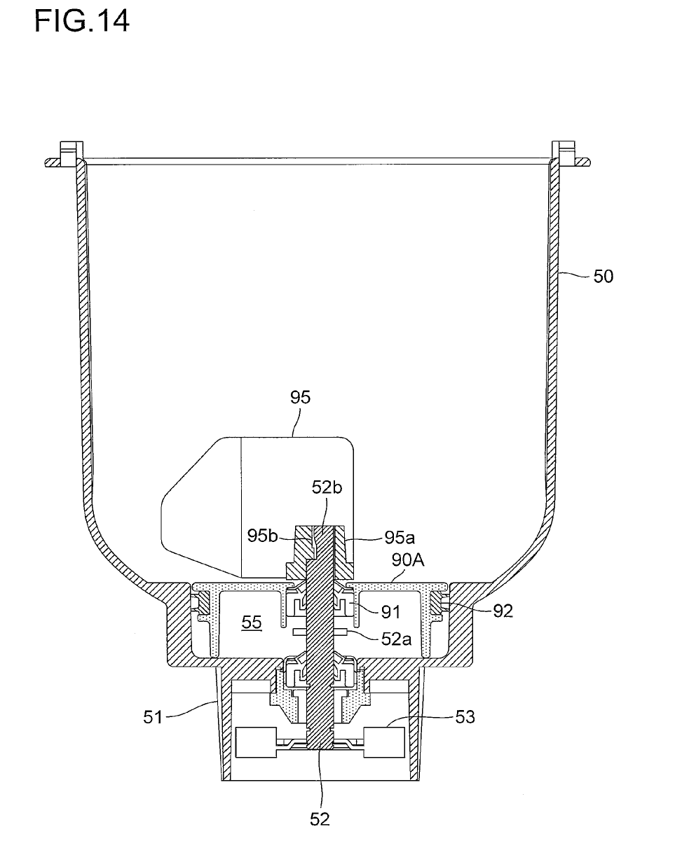

To make bread by using ready-made flour, it is necessary to change the mode of the bread container 50 from a cereal-grain grinding mode (first mode) to a ready-made flour mode (second mode). At this time, the user removes the unit of the grinding blade 54 and the cover 70 from the blade rotation shaft 52. Then, the user places a lid 90A and an independent kneading blade 95 (an embodiment of the second kneading blade of the present invention) in the bread container 50 (see FIG. 14).

The lid 90A has a shape that looks like a shallow round cup put upside down, and it is completely fitted (inserted) into the recess 55 from above. The size of the height of the lid 90A is equal to that of the depth of the recess 55, and when the lid 90A is fitted in the recess 55, it closes a top opening portion of the recess 55. A top surface of the lid 90A is substantially flush with an inner bottom surface of the bread container 50 excluding a portion corresponding to the recess 55. At a position in the center of the lid 90A, there is provided a seal portion 91 through which the blade rotation shaft 52 is rotatably provided, the seal portion 91 preventing bread ingredients from breaking into the recess 55 therethrough. An annular seal member 92 is attached to an outer periphery of the lid 90A to be in tight contact with an inner peripheral surface of the recess 55.

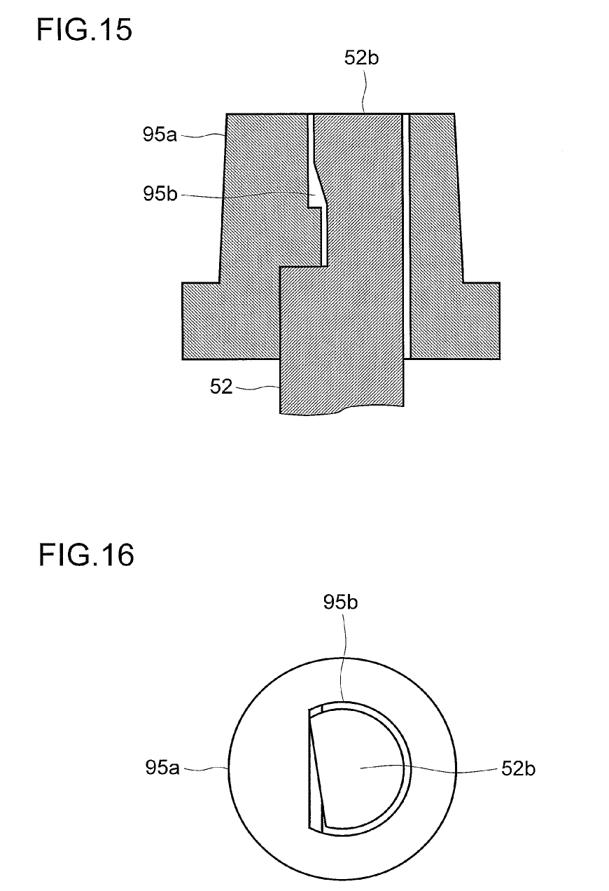

After fitting the lid 90A into the recess 55, the user fits the independent kneading blade 95 to the blade rotation shaft 52. The independent kneading blade 95 is shaped like a combination of the kneading blade 72 and the auxiliary kneading blade 77. A hub 95a of the independent kneading blade 95 is unrotatably coupled to an upper end of the blade rotation shaft 52. That is, as shown in FIGS. 15 and 16, a center hole of the hub 95a is composed of: a circular hole portion extending to a position at a predetermined height from a lower end of the center hole; and a D-shape hole portion 95b that continues from the circular hole portion to an upper end of the center hole. The blade rotation shaft 52, which is circular in section from a bottom end thereof to a position a short distance below the upper end thereof, includes a D-shape-section portion 52b extending upward from the position the short distance below the upper end of the blade rotation shaft 52. When the D-shape-section portion 52b is engaged in the D-shape hole portion 95b, the hub 95a is unrotatably coupled to the blade rotation shaft 52. Furthermore, the hub 95a and the blade rotation shaft 52 each have a step formed between the D-shape portion and the circular portion, and when the steps catch on each other, the hub 95a, and thus the independent kneading blade 95, is fastened to the upper end of the blade rotation shaft 52.

In the D-shape hole portion 95b, a protrusion is formed in a lower part of a portion thereof corresponding to the straight line of “D” to protrude toward the center of the blade rotation shaft 52. A protrusion protruding in a direction opposite to the direction in which the above protrusion protrudes is formed in an upper part of a portion of the D-shape-section portion 52b corresponding to the straight line of “D” in the D-shape-section portion 52b. The protrusion of the D-shape-section portion 52b is overhung with respect to the protrusion of the D-shape hole portion 95b. In spite of the overhanging, since there is an allowance in the engagement between the hub 95a and the blade rotation shaft 52, the blade rotation shaft 52 can be inserted into the hub 95a without difficulty. However, when power is transmitted to the blade rotation shaft 52, as shown in FIG. 16, the D-shape hole portion 95b and the D-shape-section portion 52b come to be angularly displaced from each other, and as a result, the protrusions catch each other. Thus, the independent kneading blade 95 does not come off from the blade rotation shaft 52 very easily.

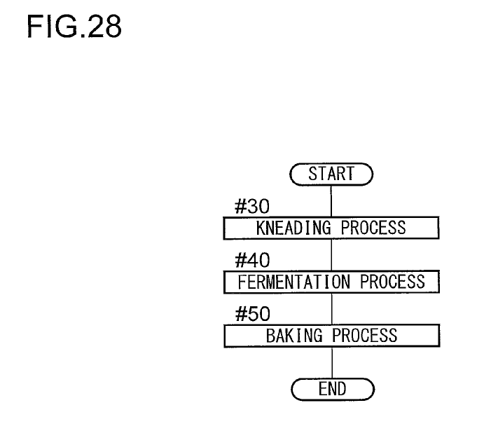

Bread making by using the bread container 50 in the ready-made flour mode described above is performed through a fourth example of bread making process shown in FIG. 28. The fourth example of bread making process does not include processes such as a pre-grinding soaking process #10, a grinding process #20, and a post-grinding soaking process #60. The fourth example of bread making process only includes a kneading process #30 performed with cereal-grain flour and liquid put in the bread container 50, and fermentation and baking processes #40 and #50, respectively, which are performed after the kneading process #30.

Incidentally, in this case as well, in rotating the blade rotation shaft 52 by using the kneading motor 60 or the grinding motor 64, the blade rotation shaft 52 may be controlled such that it goes through a stage of rotating at a low speed or intermittently before being boosted to the rated rotation speed.

By removing the grinding blade 54 and the cover 70 and then arranging the lid 90A for closing the top opening portion of the recess 55 and the independent kneading blade 95 unrotatably coupled to the blade rotation shaft 52 in the bread container as described above, it is possible to make bread by using ready-made cereal-grain flour that does not have to go through a grinding process. Instead of using two different bread containers as the bread container 50 for a cereal-grain grinding mode and for a ready-made flour mode, just the components at the bottom of the bread container 50 are replaced, and this allows the automatic bread maker 1 to be distributed for sale in a small package, and to be stored in a small space in a house.

The lid 90A is structured to be fitted into the recess 55 from above, and thus it is easy to close the recess 55. To the outer periphery of the lid 90A, an annular seal member 92 is attached to be in tight contact with the inner peripheral surface of the recess 55, and thus, when the lid 90A is fitted into the recess 55, it is possible to prevent bread ingredients from entering the recess 55 through a space between the recess 55 and the lid 90A. This helps prevent a ring-shaped protrusion from being formed in the bottom of baked bread. In addition, the annular seal member 92 functions as a cushion and this helps prevent squeak noise from occurring between the bread container 50 and the lid 90A during a bread making operation.

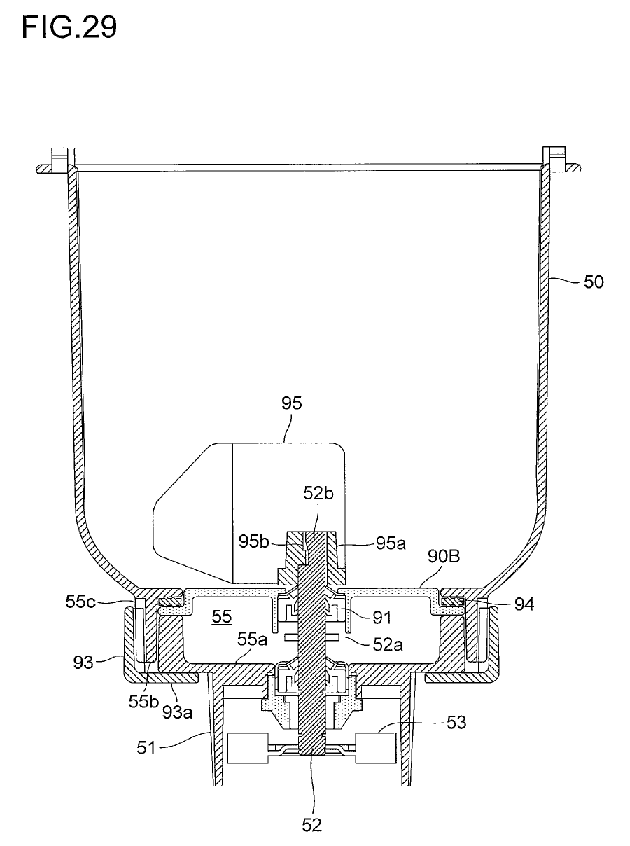

A second embodiment of the present invention is shown in FIG. 29. The second embodiment is different from the first embodiment in the following manner. A bottom portion of a recess 55 is formed, as a detachable/attachable bottom member 55a, integral with a pedestal 51. A bottom member 55a is shaped like a shallow cup and fitted inside a circumferential annular wall 55b of the recess 55. A male screw 55c is formed on an outer surface of a circumferential annular wall 55b, and an inner-flange nut 93 having an inner flange and the male screw 55c are screwed together. The inner-flange nut 93 is structured such that an inner flange 93a supports the bottom member 55a from below, and by tightening the inner-flange nut 93, the bottom member 55a can be fixed to the bread container 50.

The bottom member 55a, together with a lower edge of a top opening portion of the recess 55, holds a peripheral edge of a lid 90B. The lid 90B and the lid 90A are similar to each other in that they each have a seal portion 91 in the center; however, the lid 90B is shaped substantially like a disc while the lid 90A is shaped like a cup. An annular seal member 94 is disposed between an upper edge of the lid 90B and the lower edge of the top opening portion of the recess 55. In this state, an upper surface of the lid 90B is substantially flush with an inner bottom surface of the bread container 50 excluding the recess 55.

Here, sizes of the recess 55 and the independent kneading blade 95 are set such that the independent kneading blade 95, remaining attached to the blade rotation shaft 52, can be pulled downward from the recess 55 when the bottom member 55a is detached from the bread container 50.

Bread making by using the bread container 50 in the ready-made flour mode as described above is also performed through the fourth example of bread making process shown in FIG. 28.

With the second embodiment, the bottom member 55a of the recess 55 can be detached with baked bread remaining inside the bread container 50, to thereby separate, from the bread, components such as the grinding blade 54 and the cover 70 in the cereal-grain grinding mode, and components such as the independent kneading blade 95 and the lid 90B in the ready-made flour mode. The user can push the bread through an opening appearing after the bottom member 55a is detached, and this makes it easy to completely take the bread out of the bread container 50. Furthermore, since the bottom member 55a is fastened using the inner-flange nut 93, the bottom member 55a can be firmly fixed to the bread container 50. Furthermore, since the annular seal member 94 is disposed between the upper edge of the lid 90B and the lower edge of the top opening portion of the recess 55, when the lid 90B is fitted into the recess 55, bread ingredients are prevented from entering a space between the recess 55 and the lid 90B, and this prevents a ring-shaped protrusion from being formed on the bottom of the baked bread. Also, since the annular seal member 94 functions as a cushion, it is possible to prevent generation of squeak noise from occurring between the bread container 50 and the lid 90B in a bread baking operation.

In addition, with the structure of the second embodiment, in which the sizes of the recess 55 and the independent kneading blade 95 are set as described above, when the bottom member 55a is detached from the bread container 50, the independent kneading blade 95, remaining attached to the blade rotation shaft 52, can be pulled downward from the recess 55 through the opening appearing when the bottom member is detached. This way of detaching is made possible by the fact that, as mentioned in the description of the first embodiment, the independent kneading blade 95 does not come off from the blade rotation shaft 52 easily. This allows the user to easily pull out the independent kneading blade 95 from the bread. Also, since the bread is not caught by the kneading blade, the user can easily take the bread out of the bread container 50 completely, without trouble of shaking the bread container 50 or holding and pulling the bread.

It should be understood that the embodiments specifically described above are not meant to limit the present invention, and that many variations and modifications can be made within the spirit of the present invention.

### INDUSTRIAL APPLICABILITY

The present invention is widely usable in automatic baking machines for use mainly in general households.

### LIST OF REFERENCE SYMBOLS

1 automatic bread maker
10 body
50 bread container
52 blade rotation shaft
54 grinding blade
55 recess
55a bottom member
70 cover
72 kneading blade (first kneading blade)
90A lid
92 annular seal member
90B lid
93 inner-flange nut
94 annular seal member
95 independent kneading blade (second kneading blade)

1. An automatic bread maker which performs a bread making process with bread ingredients put in a bread container which is accommodated in a body,
wherein
the bread container has a recess formed in a bottom portion thereof; and the bread container is used in a first mode in which the recess is not closed with a lid and in a second mode in which the recess is covered with a lid.

2. The automatic bread maker of claim
wherein
the lid used in the second mode is structured to be fitted into the recess from above.

3. The automatic bread maker of claim 2,
wherein,
in the second mode, an annular seal member is attached to an outer periphery of the lid such that the annular seal member is in tight contact with an inner peripheral surface of the recess.

4. The automatic bread maker of claim 1,
wherein
a bottom portion of the recess is formed with an attachable-detachable bottom member; and
the lid used in the second mode is supported by having a peripheral edge thereof held between an edge of a top opening portion of the recess and the bottom member.

5. The automatic bread container of claim 4, wherein the bottom member is fastened and fixed to the bread container by using a nut having an inner-flange.

6. The automatic bread container of claim 4, wherein an annular seal member is disposed between the lid and the edge of the top opening portion of the recess.

7. The automatic bread maker of claim 1,
wherein
a rotation shaft is provided at a bottom portion of the bread container;
in the first mode, a grinding blade used for grinding cereal grains and a cover which is provided with a first kneading blade used for kneading bread ingredients into dough and which covers the grinding blade are attached to the rotation shaft, the cover being accommodated in the recess; and,
in the second mode, the recess is covered with the lid and a second kneading blade is attached to the rotation shaft.

8. The automatic bread maker of claim
wherein
a rotation shaft is provided at a bottom portion of the bread container;
in the first mode, a grinding blade used for grinding cereal grains and a cover which is provided with a first kneading blade used for kneading bread ingredients into dough and which covers the grinding blade are attached to the rotation shaft, the cover being accommodated in the recess; and,
in the second mode, the recess is covered with the lid and a second kneading blade is attached to the rotation shaft.

9. The automatic bread maker of claim 3,
wherein
a rotation shaft is provided at a bottom portion of the bread container;
in the first mode, a grinding blade used for grinding cereal grains and a cover which is provided with a first kneading blade used for kneading bread ingredients into dough and which covers the grinding blade are attached to the rotation shaft, the cover being accommodated in the recess; and,
in the second mode, the recess is covered with the lid and a second kneading blade is attached to the rotation shaft.

10. The automatic bread maker of claim 4,
wherein
a rotation shaft is provided at a bottom portion of the bread container;
in the first mode, a grinding blade used for grinding cereal grains and a cover which is provided with a first kneading blade used for kneading bread ingredients into dough and which covers the grinding blade are attached to the rotation shaft, the cover being accommodated in the recess; and,
in the second mode, the recess is covered with the lid and a second kneading blade is attached to the rotation shaft.

11. The automatic bread maker of claim 5,
wherein
a rotation shaft is provided at a bottom portion of the bread container;
in the first mode, a grinding blade used for grinding cereal grains and a cover which is provided with a first kneading blade used for kneading bread ingredients into dough and which covers the grinding blade are attached to the rotation shaft, the cover being accommodated in the recess; and,
in the second mode, the recess is covered with the lid and a second kneading blade is attached to the rotation shaft.

12. The automatic bread maker of claim 6,
wherein
a rotation shaft is provided at a bottom portion of the bread container;
in the first mode, a grinding blade used for grinding cereal grains and a cover which is provided with a first kneading blade used for kneading bread ingredients into dough and which covers the grinding blade are attached to the rotation shaft, the cover being accommodated in the recess; and,
in the second mode, the recess is covered with the lid and a second kneading blade is attached to the rotation shaft.
